(19) United States
(12) Patent Application Publication
(10) Pub. No.: US 2016/0057214 A1
(43) Pub. Date: Feb. 25, 2016

(54) Load Balancer System and Method for Server/Nodes in Cloud Environment

(71) Applicant: P. Ashok Anand, Chennai (IN)

(72) Inventors: P. Ashok Anand, Chennai (IN); Giribabu Yerradla, Chennai (IN); Gowri Shankar, Chennai (IN)

(21) Appl. No.: 14/784,362

(22) PCT Filed: Apr. 15, 2014
(86) PCT No.: PCT/IN2014/000235

§ 371 Date: Oct. 14, 2015

(30) Foreign Application Priority Data
Apr. 15, 2013 (IN) 1683/CHE/2013

(51) Int. Cl. H04L 29/08; G06F 11/07; H04L 12/911

(52) U.S. Cl. CPC H04L 67/1029; H04L 67/1034; H04L 47/783; G06F 11/0793; G06F 11/0709

(57) ABSTRACT

This application relates to a load balancer system and method for handling loads of the server/nodes in a cluster of a cloud network. An application with respect to a customer/client can be received at a load balancer manager/module of a cluster in a cloud network to assign the application to a server/node within the cluster. At least one server/node parameter with respect to the plurality of server/nodes within the cluster can be determined using the load balancer module to allocate the application to a master server/node in the cluster that efficiently executes the application with respect to the customer in the cloud network. The load balancer can be also adapted to monitor and determine the operating status of the plurality of server/nodes in the cluster in order thereby dynamically identify a secondary server/node that can handle the operations of the master server/node upon detecting a failure/alert at the master server/node. Such a system and method can be adapted in a wide range of cloud applications for effectively handling loads in the server/nodes of the clusters to maximize the usage of the resources in the cloud network.

### TECHNICAL FIELD

Embodiments are generally related to data processing systems and methods. Embodiments are also related to cloud computing platforms and networks. Embodiments are additionally related to load balancer system and method handling loads in the server/nodes of the clusters in order maximize the usage of the resources in the cloud network.

### BACKGROUND OF THE INVENTION

With the advancement in the Internet, cloud computing networks have become highly-scalable, dynamic service allowing cloud computing providers to provide random resources to the customers. Typically, a cloud computing network provides client access to services hosted by a collection of servers/nodes that are operatively connected within a cluster. Clients may connect to such server/nodes in the cluster in order to render an intended application successfully using the data, such as boot files, operating system images.

When designing a cluster of the cloud network to perform a service, high availability and load balancing are the two important architectural considerations for making the cluster more sophisticated. Ideally, the cluster can have a high availability so that failures of one or more server/nodes in the cluster do not significantly affect service to the clients of the cluster. Additionally, to maximize performance of the cluster under heavy usage conditions, it can be equally important to load balance the server/nodes in the cluster.

The load balancers in general provide a client access to the set of services hosted by the plurality of server/nodes within the cluster of the cloud network. Clients connect to the load balancer system, which from the client's perspective, transparently forwards them to a server/node according to a set of rules defined in the cloud network. The advent of such load balancers has opened new possibilities for the rapid and scalable deployment of web stores, media outlets, and other on-line sites or services. The load balancers are also effective in handling hosted resources such as processors, operating systems, software and other components in the cloud network.

Prior art load balancer systems and methods for handling loads with respect the server/nodes in the cluster are well-known in the art. Such prior art load balancer systems typically receives the application with respect to the customer and thereby randomly connect to one of the node/servers in the cluster by migrating a virtual machine from one hardware platform to another to ensure that the customer is not adversely affected by changes in resources for the virtual machines. The load balancers are also implemented in the field of telecommunication, mobile networks and other transaction based load balancing applications. Such prior art load balancers have very limited applications in virtual networks and are not effective handling cloud based node/servers. Further, the prior art load balancers lacks the capability to allocate the node/servers properly and efficiently in order to maximize the usage of the resources. Also, the prior art load balancers lack the ability to scale the resources in the event the cloud lacks the necessary node/server.

Based on the foregoing, it is believed that a need exists for an improved load balancer system and method for cloud networks. A need also exists for an improved system and method for handling loads in the server/nodes of the clusters in order maximize the usage of the resources in the cloud network, as described in greater detail herein.

### SUMMARY OF THE INVENTION

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved load balancer system and method.

It is another aspect of the disclosed embodiments to provide for an improved method for implementing load balancing in cloud networks.

It is further aspect of the disclosed embodiments to provide for an improved load balancer system and method for handling loads in the server/nodes of the clusters in order maximize the usage of the resources in the cloud network.

The aforementioned aspects and other objectives and advantages can now be achieved as described herein. A load balancer system and method for handling loads of the server/nodes in a cluster of a cloud network, is described herein. An application with respect to a customer/client can be received at a load balancer manager/module of a cluster in a cloud network in order to assign the application to a server/node within the cluster. At least one server/node parameter with respect to the plurality of server/nodes within the cluster can be determined using the load balancer module in order to thereby allocate the application to a master server/node in the cluster that efficiently executes the application with respect to the customer in the cloud network. The load balancer can be also adapted to monitor and determine the operating status of the plurality of server/nodes in the cluster in order thereby dynamically identify a secondary server/node that can handle the operations of the master server/node upon detecting a failure/alert at the master server/node. Such a system and method can be adapted in a wide range of cloud applications for effectively handling loads in the server/nodes of the clusters in order maximize the usage of the resources in the cloud network.

The load balancer module described herein can be configured at a bridge architecture that is connected to a plurality of server/nodes within the cluster for monitoring the status and working of the server/nodes within the cluster of the cloud network. The load balancer module can effectively monitor the server/node parameters including, but not limited to, current usage history of the server/node, past usage history of the server/node and ping time of the server/node or other computing resources in order to determine the master server/node in the cloud network. The server/node parameters are also considered to determine the secondary server/node in the cluster.

The load balancer module can be configured to maintain a status memo including the information on the server/node parameters along with other parameters of the server/node including processor cycles, bandwidth, memory, storage and other parameters. The load balancer module typically receives the applications with respect to the customer and effectively assigns the application to the appropriate master server/node by ensuring the maximum usage of the resources in the cloud network. Such a system and method for balancing loads of the server/nodes in a cluster can be effectively adapted in ensuring maximum availability server/nodes such as databases, file systems, network addresses, or other resources for applications which require a high degree of dependability, such as electronic commerce websites and other business applications.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a graphical representation of a load balancer system for maximizing the operations of server/nodes within a cluster of a cloud network, in accordance with the disclosed embodiments;

FIG. 2 illustrates a block diagram of the load balancer system for balancing loads of server/node within a cluster of a cloud network, in accordance with the disclosed embodiments; and

FIG. 3 illustrates a high level flow chart of operations illustrating logical operational steps of a method for balancing loads of server/node within a cluster of a cloud network, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

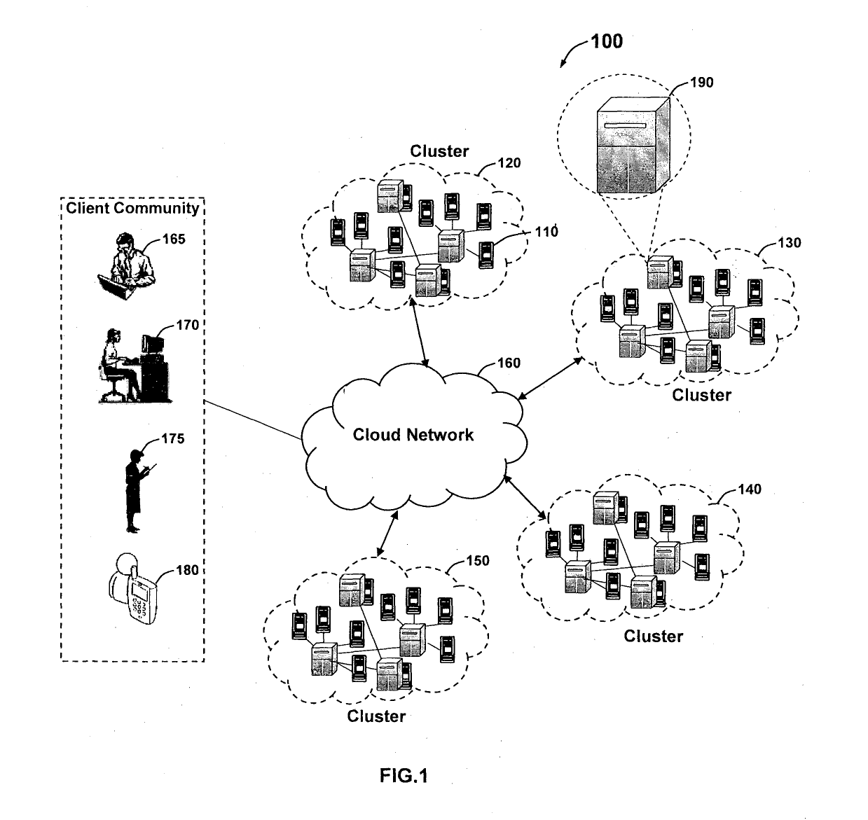

FIG. 1 illustrates a graphical representation of a load balancer system 100 for maximizing the operations of server/nodes 110 within a cluster 120-150 of a cloud network 160, in accordance with the disclosed embodiments. The embodiments and the pictorial representations provided in FIG. 1, depicts a cloud computing network 160 connected to one or more clusters 120-150 and client computers 165-180 in which the present invention may be implemented. The system 100 contains the cloud network 160, which is the medium used to provide communications links between various devices and computers connected together within the system 100.

The clusters 120-150 described herein can be a parallel or distributed system that comprises a collection of interconnected computers/servers, such as server 110 that is used as a single, unified computing unit. Members of the cluster 120-150 are referred to as server/node 110. In general, clustering may be used for parallel processing or parallel computing to simultaneously use two or more processors to execute an application or program. Clustering is a popular strategy for implementing parallel processing applications because it allows system administrators to leverage already existing computers and workstations.

Clustering also provides for increased scalability by allowing new components to be added as the system load increases. In addition, clustering simplifies the management of groups of systems and their applications by allowing the system administrator to manage an entire group as a single system. Clustering may also be used to increase the fault tolerance of the network. If one server/node suffers an unexpected software or hardware failure, another clustered server/node may assume the operations of the failed server/node. Thus, if any hardware of software component in the system fails, the user might experience a performance penalty, but will not lose access to the service.

The clients 165-180 may be, for example, personal computers or network computers users accessing the server/nodes of the clusters for data, such as boot files, operating system images, and applications with respect to the clients. Note that the system 100 may include additional clusters, server/nodes, clients, and other devices not shown. In the depicted example, the cloud network can be an Internet with a worldwide collection of networks and gateways that use the Transmission Control Protocol/Internet Protocol (TCP/IP) suite of protocols to communicate with one another.

At the heart of the Internet is a backbone of high-speed data communication lines between major nodes or host computers, consisting of thousands of commercial, government, educational, and other computer systems that route data and messages. Of course, cloud network also may be implemented as a number of different types of networks, such as for example, an intranet, a local area network (LAN), or a wide area network (WAN). FIG. 1 is intended as an example, and not as an architectural limitation for embodiments of the present invention.

A load balancer module/manager 190 is configured in association with the server/nodes 110 of the cluster 120-150 typically receives the applications with respect to the customer/client 165-180 of the cluster 120-150 in the cloud network 160 in order to assign the application 230 to a server/node 110 within the cluster 120-150. The load balancer module/manager 190 determines and monitors at least one server/node parameter with respect to the plurality of server/nodes 110 within the cluster 120-150 in order to thereby allocate the application 230 to a master server/node 240 in the cluster 120-150 that efficiently executes the application 230 with respect to the customer in the cloud network 160. The load balancer 190 can be also adapted to monitor and determine the operating status of the plurality of server/nodes 110 in the cluster 120-150 in order thereby dynamically identify a secondary server/node 250 that can handle the operations of the master server/node 240 upon detecting a failure/alert at the master server/node 240.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application.

Generally, program modules include, but are not limited to routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

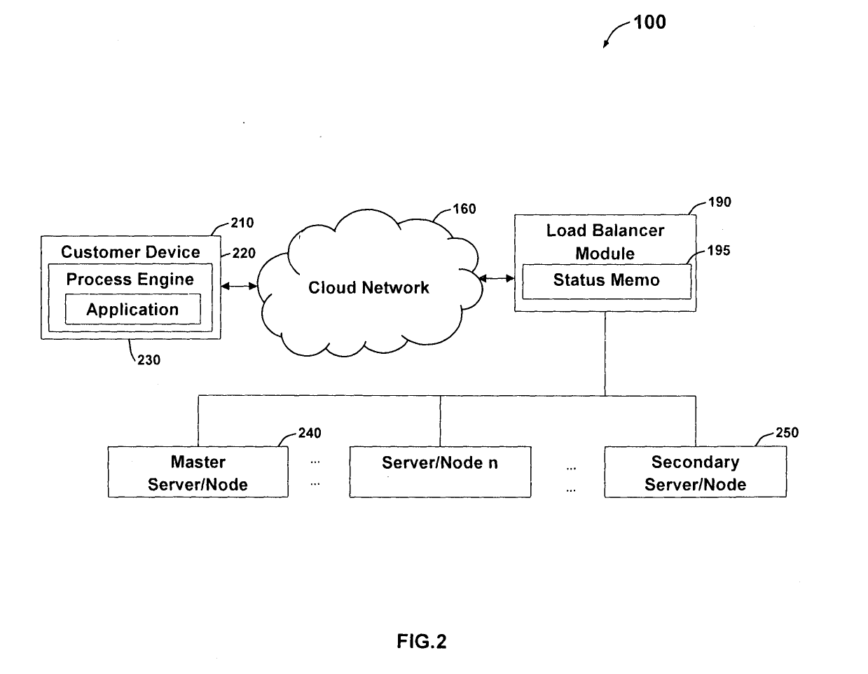

FIG. 2 illustrates a block diagram of the load balancer system 100 for balancing loads of server/node 110 within the cluster 120-150 of the cloud network 160, in accordance with the disclosed embodiments. The load balancer module 190 described herein can be configured at a bridge architecture that is connected to the plurality of server/nodes 110 within the cluster 120-150 for monitoring the status and working of the server/nodes 110 within the cluster 120-150 of the cloud network 160: The load balancer module 190 can effectively monitor the server/node parameters including, but not limited to, current usage history of the server/node, past usage history of the server/node and ping time of the server/node or other computing resources in order to determine the master server/node 240 in the cloud network 160. The server/node parameters are also considered to determine the secondary server/node 250 in the cluster 120-150.

The load balancer module 190 can be configured to maintain a status memo 260 including the information on the server/node parameters along with other parameters of the server/node including processor cycles, bandwidth, memory, storage and other parameters. The load balancer module 190 typically receives the applications with respect to the customer and effectively assigns the application 230 to the appropriate master server/node 240 by ensuring the maximum usage of the resources in the cloud network 160. Such a system for balancing loads of the server/nodes 110 in the cluster 120-150 can be effectively adapted in ensuring maximum availability server/nodes 110 such as databases, file systems, network addresses, or other resources for applications which require a high degree of dependability, such as electronic commerce websites and other business applications.

FIGS. 1-3 are intended as an example, and not as an architectural limitation with respect to particular embodiments. Such embodiments, however, are not limited to any particular application or any particular computing or data-processing environment. Instead, those skilled in the art will appreciate that the disclosed system and method may be advantageously applied to a variety of system and application software. Moreover, the present invention may be embodied on a variety of different computing platforms, including Macintosh, Windows, UNIX, LINUX, and the like. The following discussion is intended to provide a brief, general description of suitable computing environments in which the system and method may be implemented.

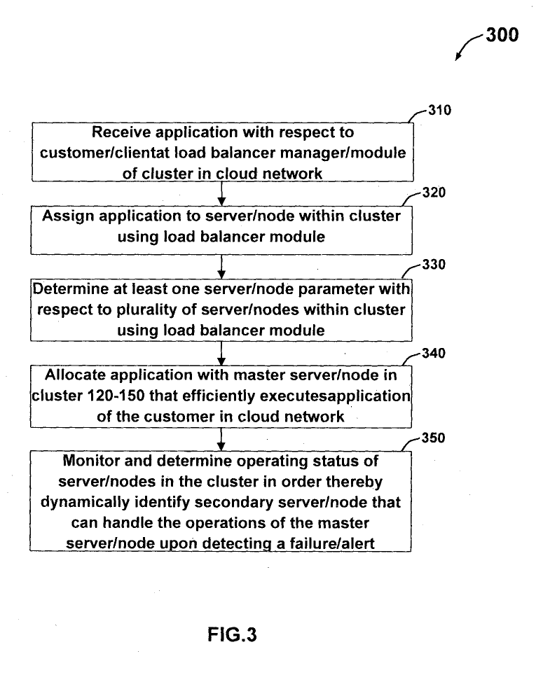

FIG. 3 illustrates a high level flow chart of operations illustrating logical operational steps of a method 300 for balancing loads of server/node 110 within the cluster 120-150 of the cloud network 160, in accordance with the disclosed embodiments. The method 300 described herein can be deployed as process software in the context of a computer system or data-processing system as that depicted in FIGS. 1-3. The application 230 with respect to a customer/client 165-180 can be received at the load balancer manager/module 190 of the cluster 120-150 in the cloud network 160 in order to assign the application 230 to the server/node 110 within the cluster 120-150, as illustrated at blocks 310 and 320 respectively. At least one server/node parameter with respect to the plurality of server/nodes 110 within the cluster 120-150 can be determined using the load balancer module 190, as depicted at block 330.

The application 230 with respect to the customer can be allocated to the master server/node 240 in the cluster 120-150 that efficiently executes the application with respect to the customer in the cloud network, as illustrated at block 340. Note that the allocation of the master server/node 240 and secondary server/node 250 can be done using a high availability manager that is well known in the art. The load balancer 190 can be also adapted to monitor and determine the operating status of the plurality of server/nodes 110 in the cluster 120-150 in order thereby dynamically identify the secondary server/node 250 that can handle the operations of the master server/node 240 upon detecting a failure/alert at the master server/node 240, as depicted at block 350. Such a system and method can be adapted in a wide range of cloud applications for effectively handling loads in the server/nodes of the clusters in order maximize the usage of the resources in the cloud network.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

I/we claim:

1. A load balancer system and method for handling loads of the server/nodes in a cluster of a cloud network, comprising:
a load balancer manager/module for receiving an application with respect to a customer/client of a cluster in a cloud network in order to assign the application to a server/node within the cluster;
t least one server/node parameter with respect to the plurality of server/nodes within the cluster can be determined using the load balancer module in order to thereby allocate the application to a master server/node in the cluster that efficiently executes the application with respect to the customer in the cloud network.

2. The system of claim 1 wherein said load balancer application monitors and determines the operating status of the plurality of server/nodes in the cluster in order thereby dynamically identify a secondary server/node that can handle the operations of the master server/node upon detecting a failure/alert at the master server/node.

3. The system of claim 1 wherein said load balancer can be configured at a bridge architecture that is connected to a plurality of server/nodes within the cluster for monitoring the status and working of the server/nodes within the cluster of the cloud network.

4. The system of claim 1 wherein said load balancer module can effectively monitor at least one of the following parameters of the server/node parameter:
current usage history of the server/node;
past usage history of the server/node; and
ping time of the server/node.

5. The system of claim 1 wherein the load balancer can be configured to maintain a status memo.

6. The system of claim 1 wherein load balancer receives the applications with respect to the customer and effectively assigns the application to the appropriate master server/node by ensuring the maximum usage of the resources in the cloud network.

7. A method for handling loads of the server/nodes in a cluster of a cloud network, comprising:
receiving an application with respect to a customer/client at a load balancer manager/module of a cluster in a cloud network in order to assign the application to a server/node within the cluster; and
determining at least one server/node parameter with respect to the plurality of server/nodes within the cluster using the load balancer module in order to thereby allocate the application to a master server/node in the cluster that efficiently executes the application with respect to the customer in the cloud network.

8. The method of claim 7 further comprising: identifying a secondary server/node that can handle the operations of the master server/node upon detecting a failure/alert at the master server/node.

9. The method of claim 7 further comprising configuring the load balancer at a bridge architecture that is connected to a plurality of server/nodes within the cluster for monitoring the status and working of the server/nodes within the cluster of the cloud network.

10. The method of claim 7 further comprising configuring the load balancer to maintain a status memo with respect to the server/node parameters.
